(19) United States
(12) Patent Application Publication
(10) Pub. No.: US 2016/0144806 A1
(43) Pub. Date: May 26, 2016

(54) VEHICLE, IN PARTICULAR RAIL VEHICLE

(71) Applicant: SIEMENS AKTIENGESELLSCHAFT, Muenchen (DE)

(72) Inventors: ANDREAS SCHAEFER-ENKELER, ROETTENBACH (DE); JUERGEN SCHLAHT, FUERTH (DE)

(21) Appl. No.: 14/895,767

(22) PCT Filed: May 21, 2014
(86) PCT No.: PCT/EP2014/060430

§ 371 Date: Dec. 3, 2015

(30) Foreign Application Priority Data
Jun. 4, 2013 (DE) 10 2013 210 333.6

(51) Int. Cl. B60R 16/02; B61K 13/00

(52) U.S. Cl. CPC B60R 16/0215; B61K 13/00; B60R 16/0207

(57) ABSTRACT

A vehicle, in particular a rail vehicle, includes at least one vehicle body, components disposed in a distributed manner, and a connecting device provided for linking the components. In order to permit the linking of components disposed in the vehicle in a distributed manner to take place quickly, easily and with lightweight devices, the connecting device includes at least one conductor unit which is coupled to the vehicle body and which has a conductor carrier unit, conductor tracks coupled thereto and at least one interface unit which is provided for forming a connection to at least one of the components.

The invention relates to a vehicle, in particular a rail-borne vehicle, having at least one vehicle body, components that are arranged in a distributed manner, and a connecting device that is provided for linking the components.

As a result of the constantly increasing variety of automated tasks and control tasks that are fulfilled by the control technology of a vehicle, the linking of components and installation space required for this purpose represents a considerable outlay with regard to the installation, weight and the costs involved during the vehicle development and production. Conventional solutions wherein individual lines are bundled together in the form of a cable harness require a considerable amount of installation space and are encumbered by the disadvantage of being heavy, in particular as a result of the individual cable sheathings. This is especially disadvantageous in particular in the case of rail-borne vehicles wherein signals are to be transmitted over long distances throughout the vehicle.

The object of the invention is to provide a vehicle wherein the components that are arranged in a distributed manner in the vehicle can be linked in a rapid and simple manner using lightweight means.

It is proposed for this purpose that the connecting device comprises at least one conductor unit that is coupled to the vehicle body and comprises a conductor carrier unit, conductor tracks that are coupled thereto, and at least one interface unit that is provided for producing a connection to at least one of the components. As a consequence, it is possible to a great extent to avoid the cost process of bundling cables together—at least for one part of the connecting device that is to be produced in the vehicle body.

The conductor carrier unit comprises at least one conductor carrier. A “conductor track” is formed by a conductive material that is arranged on a surface of the conductor carrier that is expediently produced from an insulating material and is embodied as a rigid body and/or is arranged within said rigid body and provides at least one connecting path between two mutually separate regions of the conductor unit. When transmitting information and/or operating energy between at least two of the components that are to be linked, this connecting path can be used at least as one component of an entire connection of these components and in so doing can be combined with any other connecting means such as in particular a cable unit. In contrast to a conventional cable wherein an electric conductor and its insulating sheathing are fastened to a carrier, the conductive material that forms the conductor track is advantageously connected directly to the material of the conductor carrier in the case of a conductor track. A conductor track advantageously does not move relative to the conductor carrier as a result of the conductor track being rigidly coupled to said conductor carrier, wherein the conductor track is connected to the conductor carrier preferably by means of a bonded connection. If the conductor track is arranged on a surface of the conductor carrier, said conductor carrier can be covered with a protective coating, preferably of an insulating material, at least in the region of the conductor track so as to provide mechanical and/or electromagnetic protection of said conductor track.

The amount of conventional installation space that is required in particular by cable sheathings can be reduced by virtue of using conductor tracks that are arranged in a compact manner on a surface of the conductor carrier and/or are arranged in said conductor carrier. In contrast to conventional conductors that are provided with such sheathings, it is therefore possible to provide a lightweight and compact connecting device as a result of the comparatively low weight of the conductor tracks and their common conductor carrie. The interface unit is preferably arranged on a surface of the conductor carrier and rigidly connected thereto. In particular, the interface unit can comprise at least one plug-in facility that is arranged on a surface of the conductor carrier.

The conductor unit that is coupled to the at least one vehicle body can be arranged outside the vehicle body. However, if the connecting device is provided for producing control lines between the components, it is advantageous that the conductor unit is arranged in an interior space that is encompassed by the vehicle body.

In accordance with a preferred embodiment of the invention, it is proposed that the conductor unit extends in the longitudinal direction of the vehicle body over at least a considerable part of the vehicle body length. As a consequence, it is possible in particular to greatly reduce the installation space required and the weight, the reason being that it is possible to considerably reduce the amount of cabling required for linking the components over long connecting paths. In particular, it is possible in an advantageous manner to provide connecting paths between two end regions of the vehicle body by means of the conductor unit. The conductor unit in accordance with the proposed embodiment comprises in an advantageous manner a main direction of extension that corresponds to the longitudinal direction of the vehicle body. The term “considerable part” is understood to mean in particular at least 50%, particularly advantageously at least 75%, of the vehicle body length.

Moreover, it is proposed that the conductor carrier unit comprises at least one conductor carrier that is embodied as a carrier plate, whereby it is possible to achieve a constructively simple and particularly lightweight connecting device.

The conductor carrier unit can comprise a single, connected conductor carrier that is coupled to the vehicle body. However, if connecting paths are to be provided over long distances by means of the conductor unit, it is proposed in order for the conductor unit to be able to be handled in an advantageous manner, in particular during its installation in the vehicle, that the conductor carrier unit comprises a set of conductor carriers that are arranged in series one behind the other in the longitudinal direction of the vehicle body, said conductor carriers being connected one to the other by means of cabling in each case over a short distance. The term “short distance” is understood to mean in particular a distance that is less than 10%, in particular advantageously less than 5% of the extension of the conductor unit in its main direction of extension. The conductor carriers are embodied in a particularly advantageous manner at least essentially in a structurally identical manner, whereby it is possible to achieve a production process that is as uniform as possible.

Moreover, it is proposed that the interface unit is connected to the allocated components by means of a flexible cable unit. As a consequence, it is possible to achieve a flexible conductor guiding arrangement with respect to the path from the conductor unit as far as the components.

Furthermore, it is possible to utilize the installation space in an optimum manner if the conductor unit is arranged in a space that extends in the region of a boundary wall of the vehicle body and along said boundary wall. The boundary wall can be used in an advantageous manner for fastening the conductor unit, in that fastening means fasten the conductor unit to the boundary wall. It is preferred that the space is defined from one side by the boundary wall. An arrangement of the space “in the region” of the boundary wall and “along” this boundary wall is to be understood to mean in particular that the space—when viewed in the normal direction with respect to the boundary wall, in other words perpendicular to the main plane of the boundary wall—is defined by a plane that extends in a parallel manner with respect to the boundary wall and comprises a spacing with respect to the boundary wall that amounts at a maximum to 25% of the extension of the vehicle body in this normal direction. In particular, this plane can be formed by a unit, such as for example in particular a protective wall and/or partition wall.

It is proposed in this connection that the vehicle body comprises a passenger compartment that is provided for accommodating passengers, wherein the space is arranged between the boundary wall and the passenger compartment. As a consequence, it is possible to arrange the space within the vehicle body in a compact manner that protects the conductor unit. The term “between” relates in this case to the normal direction with respect to the boundary wall, said normal direction being perpendicular to the main plane of the boundary wall. In order to separate the space for the conductor unit from the passenger compartment, it is possible to use in particular a partition wall that extends in parallel to the boundary wall.

A boundary wall of the vehicle body corresponds in particular to a wall of the vehicle body shell. Walls of the vehicle body shell are a determining factor for the vehicle body length, in their assembled state they encompass in cooperation the vehicle body inner space and form outer surfaces of the vehicle body. It is possible for the arrangement of the space to use all four boundary walls that encompass the inner space of the vehicle body, said walls being namely a roof wall, a floor wall or two side walls that are adjoining said roof wall and floor wall. However, an optimum utilization of the installation space is achieved if the conductor unit is arranged in the roof region of the vehicle body. This is to be understood in particular to mean that the space extends in the region of the roof wall of the vehicle body and along said vehicle body.

As already mentioned above, the conductor tacks can be used to transmit operating energy and/or information. In the latter mentioned case, the conductor tracks can form in particular control lines for which electrical signals that have a low voltage and current strength are transmitted and it is therefore particularly appropriate to link the components by means of conductor tracks. The term “control line” is to be understood to mean in particular a line that is used to connect at least one functional component to a control component that is provided so as to control said functional component. The control line is therefore to be suitable for transmitting control signals of the control component to the functional component and where necessary messages from the functional component to the control component.

The vehicle can be embodied in particular as a rail-borne vehicle wherein components are already linked typically over particularly long distances. In a particular embodiment of the invention, the vehicle is embodied as a rail-borne multiple train unit with multiple vehicle bodies that are coupled one to the other and in each case a different control unit is allocated to said vehicle bodies, wherein connecting devices are provided that are used for the purpose of connecting the conductor units in pairs. In a multiple train unit of this type, control lines are typically arranged between components that are allocated to different vehicle bodies, in particular are in different vehicle bodies, and therefore are provided over particularly long distances. It is possible to considerably reduce the outlay with regard to the cabling by virtue of using multiple conductor units that are coupled in each case to a different vehicle body.

An exemplary embodiment of the invention is explained with reference to the drawings, in which:

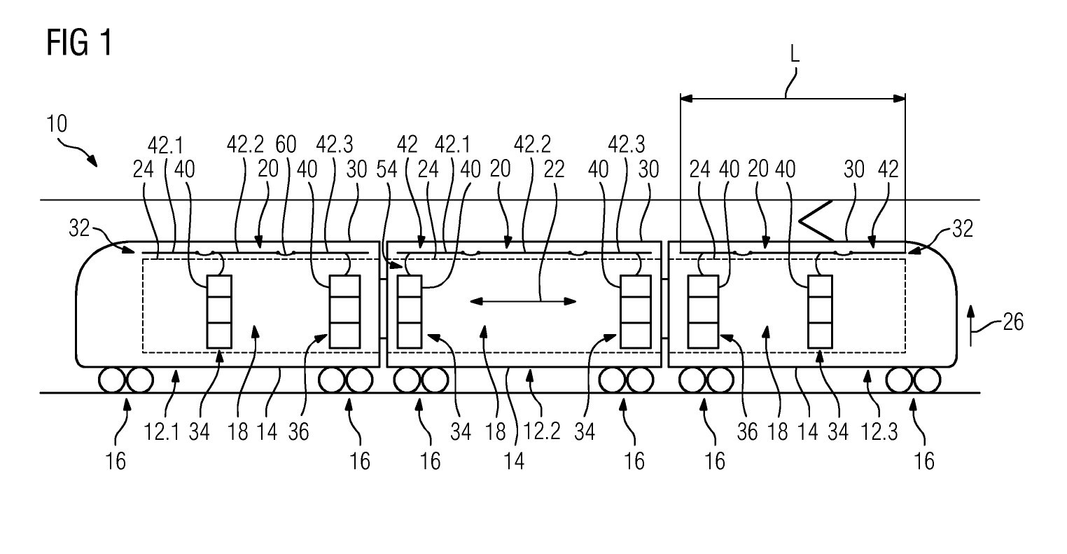

FIG. 1 illustrates a side view of a vehicle that is embodied as a multiple train unit,

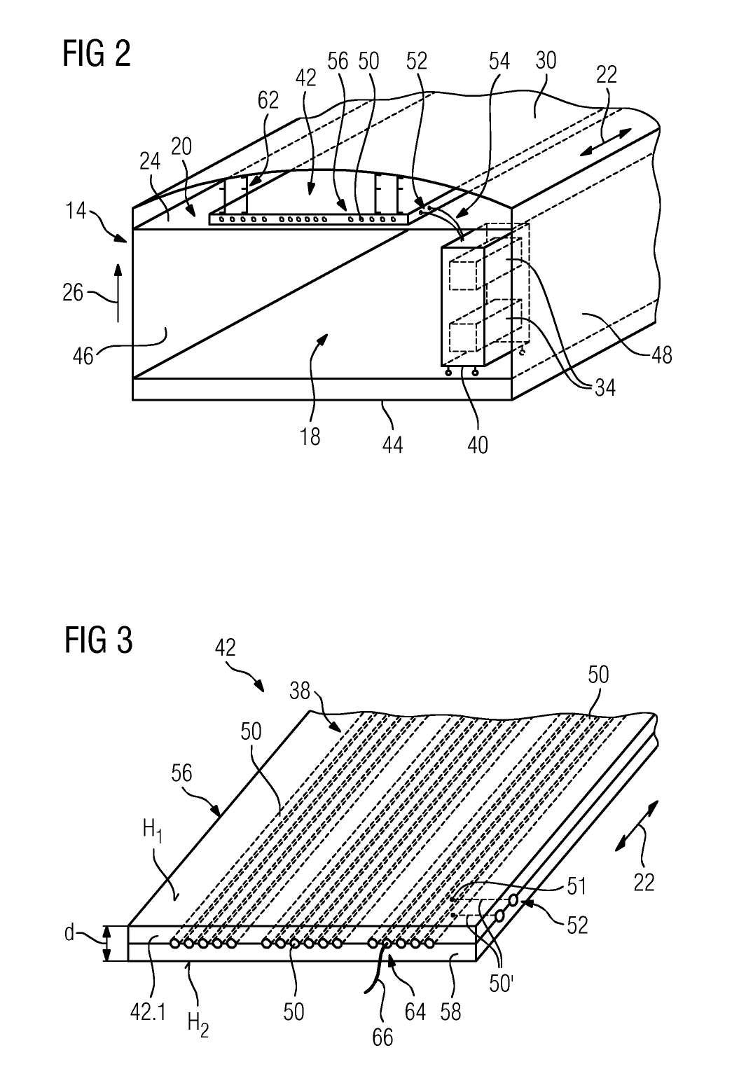

FIG. 2 illustrates a perspective view of a vehicle body of the vehicle illustrated in FIG. 1, and

FIG. 3 illustrates a conductor unit arranged in the vehicle body.

FIG. 1 illustrates a greatly schematic side view of a vehicle 10 that is embodied as a rail-borne vehicle. It is embodied in particular as a multiple train unit used in public transport and is therefore provided for conveying passengers. The vehicle 10 comprises in particular three cars 12.1, 12.2 and 12.3 that are coupled one to the other. The illustrated embodiment described below is exemplary. In alternative embodiments, the vehicle 10 can be embodied as a group of passenger trains that are being pulled by a locomotive or as a one-part or multiple-part omnibus for road transport.

Each car 12.1 comprises a vehicle body 14 that is supported on rails by means of running gear 16, in particular pivot bogies. For the sake of clarity, the description is omitted of the cladding elements with which the vehicle bodies 14 are equipped.

The vehicle bodies 14 encompass in each case a passenger compartment 18 that is provided for accommodating passengers and is equipped in particular with a seating arrangement, not illustrated. A space 20 is provided in the roof region of the vehicle body internal compartment and said space extends in the longitudinal direction 22 of the vehicle body 14 and is separated from the passenger compartment 18 by means of a partition wall 24 (see also FIG. 2). When viewed in the vertical direction 26, in other words in a perpendicular manner with respect to the track bed, the space 20 is arranged between the passenger compartment 18 and the roof of the vehicle body 14, said roof representing a boundary wall 30 of the vehicle body 14.

This longitudinally extended space 20 is used as a technical space for the installation of elements of a connecting device 32 that is used for linking components 34, 36 that are distributed in the respective vehicle body 14 and in the entire vehicle 10. These components 34, 36 include functional components 34 that are provided in each case for fulfilling a specific function in the vehicle 10 or in the respective car 12, and control components 36 that are used for controlling the functional components 34 or for coordinating the tasks associated with the functions. The functional components 34 and the control components 36 are linked by means of control lines 38, illustrated further in FIG. 3. The components 34 or 36 can be installed in particular in device cabinets 40 of the passenger compartment 18.

The connecting device 32 comprises conductor units 42 that are allocated in each case to a different vehicle body 14. The conductor units 42 are arranged in each case in the space 20 of the corresponding vehicle body 14 and extend in the longitudinal direction 22 of the vehicle body 14. One of these conductor units 42 is illustrated further in FIGS. 2 and 3.

FIG. 2 illustrates one of the vehicle bodies 14 of the vehicle 10 in a perspective view. The passenger compartment 18 and the space 20 are in particular evident and said passenger compartment and space are encompassed by opposite lying—when viewed in the vertical direction 26—boundary walls 30 (vehicle body roof), 44 (vehicle body floor) and also by vertical and opposite lying—when viewed in the perpendicular direction with respect to the longitudinal direction 22 and vertical direction 26—boundary walls 46 and 48 (vehicle body sides) of the vehicle body 14. The space 20 and the passenger compartment 18 are separated from one another by means of the partition wall 24 that extends horizontally and in the longitudinal direction 22 of the vehicle body 14 or parallel to the boundary wall 44. The conductor unit 42 is arranged in the space 20 and said conductor unit comprises conductor tracks 50 and an interface unit 52. This interface unit 52 that is allocated to a specific component 34 or 36 or to a group of components 34 or 36 is used for the purpose of connecting the conductor tracks 50 to the allocated components or to the group. In the example under consideration, a group of components 34 is allocated to the illustrated interface unit 52, said components being installed in a device cabinet 40 of the passenger compartment 18. The interface unit 52 is designed in each case so as to be conductively connected to a flexible cable unit 54 to which the components 34 are connected. In particular, the interface unit 52 can comprise a plug-in facility that corresponds to at least one plug-in element of the cable unit 54.

The conductor unit 42 is illustrated further in FIG. 3. Said conductor unit comprises a conductor carrier unit 56 having a rigid conductor carrier 42.1 that is made from an insulating material. The conductor tracks 50 are formed in each case from a conductive material that is applied on the conductor carrier 42.1 that is common for the conductor tracks 50 and is embodied as a carrier plate. This material is applied to the conductor carrier 42.1 in such a manner that it cannot be separated therefrom without damaging the conductor carrier 42.1 or the conductor tracks 50. The material is fastened to the conductor carrier 42.1 in particular by means of a bonded connection so as to form the conductor tracks 50. In order to provide mechanical and electromagnetic protection of the conductor tracks 50, the conductor carrier unit 56 comprises a coating 58 of an insulating material that covers at least the conductor tracks 50 and in particular at least one considerable part of the conductor carrier 42.1.

Conductor tracks 50 are provided that extend in the longitudinal direction of the conductor unit 42, in other words in the longitudinal direction 22 of the vehicle body 14. These conductor tracks 50 are used as main conductor tracks that transmit signals over long distances. Moreover, conductor tracks are provided in particular that extend over the entire length of the conductor carrier 42.1. Conductor tracks 50′ are further provided that in each case connect a conductor track 50 that is embodied as a main conductor track to the interface unit 52 and for this purpose are branched in particular from the conductor track 50 at a branching point 51.

The conductor carrier unit 56 is embodied in a plate-shaped manner and comprises two opposite lying, mutually parallel main planes H₁ and H₂ that extend horizontally or in parallel with respect to the boundary wall 44 of the vehicle body 14 and are spaced apart from one another by way of a spacing that corresponds to the plate thickness d and amounts to a few centimeters.

As is evident in FIG. 1, the conductor units 42 extend in the respective vehicle body 14 in the longitudinal direction 22 of the vehicle body 14 over at least a considerable part of the vehicle body length. In particular, the conductor units 42 each comprise a length L that amounts to at least 75% of the vehicle body length.

The conductor carrier unit 56 of the conductor unit 42 in each vehicle body 14 comprises a set of multiple conductor carriers 42.1, 42.2, 42.3 that are embodied in particular in an identical manner and in each case as a carrier plate, said conductor carriers being arranged separately from one another or in a row one behind the other in the longitudinal direction 22 of the vehicle body 14. The above description relating to the conductor carrier 42.1 equally applies to the conductor carriers 42.2, 42.3. The conductor carriers 42.1, 42.2, 42.3 are connected one to the other by means of cabling in each case by means of a flexible cable unit 60 by means of which the short distance between two adjacent conductor carriers is bridged. The conductor tracks 50 of the conductor carriers 42.1, 42.2 or 42.3 that are to be connected are connected one to the other by means of cable units 60 so that lines, in particular control lines 38, can be produced for linking the functional components 34 to the control components 36 and said lines extend along the entire conductor unit 42.

In an alternative embodiment, the conductor carrier units 56 are formed in the vehicle bodies 14 in each case by a single, connected conductor carrier.

As already mentioned above, the space 20 in which the conductor unit 42 is arranged is arranged in the exemplary embodiment being considered in the roof region of the respective vehicle body 14. The space 20 extends in the region and along the boundary wall 30 of the vehicle body and is located above the passenger compartment 18 between this and the boundary wall 30. In further embodiments, it is feasible that the space 20 for the conductor unit 42—when viewed in a perpendicular direction with respect to the longitudinal direction 22 and with respect to the vertical direction 26—extends at the side adjacent to the passenger compartment 18 between said passenger compartment and the boundary wall 46 or 48. Said space extends in the region of the boundary wall 46 or 48 and along said boundary wall. In a further alternative embodiment, it is feasible that the space 20 is arranged below the passenger compartment 18 and—when viewed in the vertical direction 26—between said passenger compartment and the boundary wall 44. Said space extends in the region of the boundary wall 44 and along said boundary wall.

In the case of an arrangement along the boundary walls 30 or 44, the conductor unit 42 or the main planes H₁, H₂ of the conductor carrier unit 56 extend horizontally, in other words in parallel with respect to the boundary wall 44. In the case of an arrangement along a side wall 46 or 48, the conductor unit 42 or the main planes H₁, H₂ extend in a vertical manner, in particular parallel, with respect to the plane that is formed by the vertical direction 26 and the longitudinal direction 22.

The conductor unit 42 can be fastened to the corresponding boundary wall 30, 44, 46 or 48 by means of a fastening unit. In the embodiment in accordance with FIG. 2, a fastening unit 62 is provided by means of which the conductor unit 42 is fastened in particular to the conductor carrier 42.1 at the boundary wall 30.

The conductor units 42 of the different cars 12.1, 12.2, 12.3 are connected one to the other in pairs. As a consequence, it is possible to provide control lines 38 that render it possible in different cars to transmit signals between components 34, 36. For this connection, the conductor units 42 are connected in each case to connecting devices 64 by means of which the conductor tracks 50 are connected to corresponding conductor tracks of the conductor unit 42 that is to be coupled. In the embodiment being considered, the connecting devices 64 are embodied in each case as a plug-in facility by means of which it is possible to provide a plug-in connection to a cable unit 66, which connects corresponding connecting devices 64 of the two conductor units 42 that are to be coupled (cf. FIG. 3). The cable unit 66 that is not illustrated in FIG. 1 for the sake of clarity can comprise multiple cable pieces that are connected one to the other. A middle cable piece can be a conventional, for example standardized or standard, cable connection between two adjacent cars 12.

1-10. (canceled)

11. A vehicle, comprising:
at least one vehicle body;
components distributed in said at least one vehicle body; and
a connecting device for linking said components, said connecting device including at least one conductor unit being coupled to said at least one vehicle body and having a conductor carrier unit, conductor tracks coupled to said conductor carrier unit and at least one interface unit for producing a connection to at least one of said components.

12. The vehicle according to claim 11, wherein said at least one vehicle body has a longitudinal direction and a length, and said at least one conductor unit extends in said longitudinal direction over at least most of said length.

13. The vehicle according to claim 11, wherein said conductor carrier unit includes at least one conductor carrier constructed as a carrier plate.

14. The vehicle according to claim 11, wherein said at least one vehicle body has a longitudinal direction, said conductor carrier unit includes a set of conductor carriers disposed one behind the other in said longitudinal direction, and cabling interconnects said conductor carriers over short distances.

15. The vehicle according to claim 11, which further comprises a flexible cable unit connecting said interface unit to said components allocated to said interface unit.

16. The vehicle according to claim 11, wherein said at least one vehicle body has a boundary wall defining a space extending next to said boundary wall, and said at least one conductor unit is disposed in said space and along said boundary wall.

17. The vehicle according to claim 16, wherein said at least one vehicle body includes a passenger compartment for accommodating passengers, and said space is disposed between said boundary wall and said passenger compartment.

18. The vehicle according to claim 16, wherein said at least one vehicle body has a roof region at said boundary wall, and said at least one conductor unit is disposed at said roof region.

19. The vehicle according to claim 11, wherein said conductor tracks form control lines.

20. The vehicle according to claim 11, wherein:
the vehicle is a rail-borne multiple train unit;
said at least one vehicle body includes a plurality of vehicle bodies being coupled to one another;
said at least one conductor unit includes different conductor units each being allocated to a respective one of said vehicle bodies; and
connecting devices interconnect said conductor units in pairs.

21. The vehicle according to claim 11, wherein the vehicle is a rail-borne vehicle.
